(19) United States
(12) Patent Application Publication
(10) Pub. No.: US 2024/0310341 A1
(43) Pub. Date: Sep. 19, 2024

(54) COLORIMETRIC SENSOR AND ITS PREPARATION PROCEDURE

(71) Applicant: MATERIAS S.r.l., Napoli (IT)

(72) Inventors: Luca DE STEFANO, Napoli (IT); Selene DE MARTINO, Piano di Sorrento (IT); Mario BATTISTI, Ercolano (IT); Bruno MIRANDA, San Gennaro Vesuviano (IT)

(73) Assignee: MATERIAS S.r.l., Napoli (IT)

(21) Appl. No.: 18/263,636

(22) PCT Filed: Jan. 31, 2022
(86) PCT No.: PCT/IB2022/050820

§ 371 Date: Jul. 31, 2023

(30) Foreign Application Priority Data
Feb. 3, 2021 (IT) 102021000002384

(51) Int. Cl. G01N 31/22

(52) U.S. Cl. CPC G01N 31/225

(57) ABSTRACT

A process for the preparation of a colorimetric device (sensor) for detecting oxidizing agents, in particular for detecting the presence of oxygen comprising or consisting of—subjecting, to UV irradiation comprised between 200 and 400 nm, a pre-polymer solution comprising at least one redox dye, at least one semiconductor material and at least one di- or tri-acrylate monomer. Such device and its use in the packaging field, e.g. for packaging food or pharmaceutical products, represent aspects of the application of said devices.

### FIELD OF THE INVENTION

The present invention regards a process for the preparation of a colorimetric device (sensor) for detecting oxidizing agents, in particular for detecting the presence of oxygen; such device and its use in the packaging field, e.g. for packaging food or pharmaceutical products, represent further aspects of the invention.

### STATE OF THE ART

Oxygen is known to oxidize foods and drugs due to its high reactivity, and to denature the active principles of products. For this reason, an oxygen indicator is often positioned within the MAP (Modified Atmosphere Packaging) package in order to control the preservation of a product, e.g. food or drug, in inert atmosphere.

Presently, there are various types of oxygen indicators available on the market. Some of these are based on the redox photocatalytic reaction which allows a switch of the color in response to light irradiation; such indicators comprise a redox dye which has a different color at the reduced state than at the oxidized state. In particular, the oxygen indicators present on the market use methylene blue (MB), which is colorless in the reduced form and becomes blue in the presence of oxygen i.e. it is blue in oxidized form.

Other colorimetric sensors or devices that detect the presence of oxygen are known in the literature. For example, the patent application WO03/021252 describes an irreversible sensor for detecting oxidizing agents comprising redox dye/sacrificial electron donor/semiconductor material/polymer. Such sensor is prepared and activated in separate steps. In particular the polymer and the remaining starting materials are mixed in solution to obtain a liquid composition (ink), which is subsequently placed on a glass medium that is rotated by using a rotor (casting) to obtain a film, which is then dried; the obtained film is colored due to the presence of the redox dye at the oxidized state, for example it is blue of the redox dye is methylene blue. Subsequently, the colored film is activated by means of irradiation in the near UV in anaerobic conditions; in such conditions the semiconductor absorbs a light photon of the near UV and generates an electron-gap pair; the effect of the UV activation determines the reduction of the redox dye and the oxidation of the sacrificial electron donor (weak reducing agent). Since both the reduced redox dye and the oxidized sacrificial electron donor are colorless, the film obtained following activation by means of irradiation in the near UV in anaerobic conditions is colorless. The colorless film prepared in WO252 is stable in anaerobic conditions, but following exposure to air the original color of the film is readily restored.

WO2016/064849 describes a reversible sensor for rewritable media comprising redox dye/semiconductor material/polymer. Such sensor is prepared and activated in separate steps. Also in this case, the polymer and the remaining starting materials are mixed in solution to obtain a liquid composition, which is subsequently placed on a glass, plastic or paper medium, on which the solution is allowed to evaporate (drop casting); the film obtained is colored due to the presence of the redox dye at the oxidized stated, e.g. it is blue if the redox dye is methylene blue. Subsequently, the colored film is activated by means of irradiation with UV, to give the colorless film. The colorless film prepared in WO849 is reversible and can be used for multiple cycles.

Galan et al., Sensors and Actuators B (2010), 144. 49-55, attained a reversible oxygen sensor comprising MB (redox dye)/DBK (photoinitiator)/acrylic polymer. The preparation and the activation of such sensor occurs in a single step. MB, DBK and the acrylic monomer are mixed in solution to obtain a colored liquid composition, a thin film of the composition is placed on a glass medium and irradiated with UV for 5 minutes in nitrogen atmosphere. In the approach of Galan et al., the sensor does not comprise the semiconductor material; in this embodiment, it is the photoinitiator DBK that is activated under UV radiation, generating free radicals; during the irradiation, two reactions simultaneously take place 1) the polymerization of the acrylic monomer and 2) the reduction of MB from the colored oxidized form to the colorless reduced LMB form.

Islam, et al., Science of the Total Environment (2020), 704, 135406, have attained reusable photocatalytic paints based on TiO₂ nanoparticles in acrylic resins. The paint described herein does not comprise the redox dye and is used for a different application, i.e. for the photocatalytic degradation of pollutant agents, e.g. MB. The preparation and the activation of such acrylic paint occurs in a single step. TiO₂ and the acrylic resin are mixed in solution, the mixture is subjected to irradiation UV for a time comprised between 30 minutes and 4 hours to obtain a polymerized solid mass (TiO₂@polymer).

### SUMMARY OF THE INVENTION

The Applicant has faced the problem of how to optimize, both in terms of times and costs, the method for preparing a colorimetric sensor for detecting oxidizing agents.

The Applicant has studied different types of work conditions and materials and has advantageously attained a simplified process which comprises the preparation and the activation of a colorimetric sensor in a single step.

Contrary to that reported by Galan et al., which teaches that the specific photoinitiator DBK is necessary in order to trigger the polymerization reaction of an acrylic monomer and reduction reaction of MB from the colored oxidized form to the colorless reduced LMB form, the Applicant has found that also a semiconductor material is capable of catalyzing both these reactions, ensuring that the preparation and the activation of a colorimetric sensor can be advantageously attained in a single step.

Contrary to that reported by Islam et al., which teaches that the polymerization of an acrylic resin catalyzed by a semiconductor material requires long irradiation times, the Applicant has found that, by selecting specific acrylic resins based on at least one di- or tri-acrylate monomer, also a semiconductor material is capable of preparing and activating a colorimetric sensor after a few minutes of irradiation at UV light.

Therefore the Applicant has found an alternative preparation method, which is easier, quicker and less costly for preparing and activating, in a single step, a sensor for detecting oxidizing agents comprising a redox dye/semiconductor material/polymer matrix system based on at least one di- or tri-acrylate monomer.

A further advantage of the preparation method in accordance with the invention is represented by the fact that the selected acrylic resins allow preparing modulated sensors characterized by specific response times to the oxygen based on the molecular weight of the corresponding monomer; such sensors are therefore adaptable to various applications as a function of the recoloring time thereof.

In addition, the Applicant has found that in the presence both of a semiconductor material and of a photoinitiator, it is possible to trigger the polymerization reaction of an acrylic monomer even with high molecular weight, e.g. up to 10000 Da.

A further advantage of the preparation method in accordance with the invention, when both the semiconductor material and the photoinitiator are present, is represented by the fact that the sensor obtained is reversible and also more stable mechanically.

A further advantage of the preparation method in accordance with the invention, when the semiconductor material, the photoinitiator as well as a sacrificial electron donor (SED) material are present, is represented by the fact that the sensor obtained is reversible and usable for a higher number of cycles than the number of cycles of the sensor where there is no SED present.

Therefore, a first object of the invention is represented by a process for the preparation and activation of a sensor for detecting oxidizing agents comprising or consisting of
subjecting to UV irradiation, comprised between 200 and 400 nm, a pre-polymer solution comprising at least one redox dye, at least one semiconductor material and at least one di- or tri-acrylate monomer.

In the process in accordance with the invention, the semiconductor exerted a double photocatalytic activity, determining 1) the polymerization of the monomer and 2) the reduction of the redox dye from the colored oxidized form to the colorless reduced form.

As demonstrated in the experimental part, in particular in the examples 1a and 1b, also by using a semiconductor material in place of a photoinitiator it is possible to prepare and activate a colorimetric sensor in a single step, hence the process in accordance with the invention is simpler and less expensive than the processes described in WO252 and WO849 in which preparation and activation of the sensor occurred in separate steps. In addition, as demonstrated in the examples from 1a to 1e, a few minutes of irradiation at UV light are sufficient for preparing and activating such sensor.

By using both a semiconductor material and a photoinitiator, it is possible to trigger the polymerization reaction also of an acrylic monomer with high molecular weight, e.g. up to 10000 Da, see example 1e.

In addition, it is possible to obtain films that completely return to the initial color, which are reversible and which have improved mechanical characteristics, being more elastic.

As reported in the example 3, the colorimetric transition of all the films reaches the plateau within 90 minutes; by selecting the at least one monomer based on the molecular weight, it is possible to prepare modulated sensors characterized by specific oxygen response times, adaptable to various applications as a function of their recoloring time, see FIG. 3A, trace relative to the film 3 (black square) and to the film 4 (gray square), and FIG. 3B, relative to film 5.

A second object of the present invention is a single-layer sensor for detecting oxidizing agents comprising
at least one redox dye,
at least one semiconductor material and
a polymer matrix based on at least one di- or tri-acrylate monomer obtained by means of the process in accordance with the first object of the invention.

A third object of the present invention is a single-layer sensor for detecting oxidizing agents comprising
at least one redox dye,
at least one semiconductor material and
a polymer matrix based on at least one di- or tri-acrylate monomer.

A fourth object of the present invention is a multilayer sensor for detecting oxidizing agents comprising
a single-layer sensor in accordance with the second or with the third object of the invention, and
at least one further polymer layer based on at least one di- or tri-acrylate monomer.

A fifth object of the present invention is the use of a single-layer sensor in accordance with the second or third object of the invention or of a multilayer sensor in accordance with the fourth object of the invention, for detecting oxidizing agents, in the packaging field, e.g. for packaging food or pharmaceutical products.

### BRIEF DESCRIPTION OF THE FIGURES

FIG. 1 represents the spectrum DLS of a sample of TiO₂ particles prepared as described in the example 1; on the y-axis, the volume % is represented, on the x-axis the size (d-nm) is represented.

FIGS. 2A-2E respectively show the visible spectrum between 550 nm and 750 nm of the MB in the single-layer films from 1 to 5 and FIG. 2F shows the spectrum of the MB in the multilayer film 6; on the y-axis the absorbance is represented, on the x-axis the wavelength (nm) is represented.

FIG. 3A shows the kinetics of recoloring the single-layer films 1 (black triangle) and 2 (gray triangle) not comprising the photoinitiator compared with the kinetics of the films 3 (black square) and 4 (gray square) comprising the photoinitiator; FIG. 3B shows the recoloring kinetics of the single-layer film 5. FIG. 3C shows the recoloring kinetics of the multilayer film 6 (gray circle) compared with the kinetics of the single-layer film 3 (black square); on the y-axis the absorbance is represented, on the x-axis the time is represented.

FIGS. 4A-4C show the photograph images of the films 3, 4 and 5 at 1, 5, 15, 30, 60 and 90 min.

### DETAILED DESCRIPTION OF THE INVENTION

Preferably, the at least one redox dye, suitable in accordance with the invention, is a thiazine dye, for example methylene blue-MB, thionine, toluidine blue; an oxazine dye, for example resazurin, safranin O, celestine blue; an azine dye, for example violet, cresol acetate, azure A; an indophenol dye, for example dichloroindophenol; an indigo dye, for example indigo and indigo carmine; a viologen dye, for example heptyl or benzyl viologens; a eurhodin dye, for example Neutral Red (NR); and mixtures thereof.

Advantageously, the preferred redox dyes in accordance with the invention are for example MB. Neutral Red (NR), heptyl or benzyl viologens.

The systems with MB are extremely sensitive to oxygen since MB is quickly re-oxidized by oxygen already at oxygen concentrations equal to or greater than 0.1%; the viologens represent a valid alternative as dye, since they are less sensitive and re-oxidize at oxygen concentrations equal to or greater than 4%.

Preferably, the at least one semiconductor material suitable in accordance with the invention is for example a metal oxide (MOSs), for example TiO₂, ZnO, SnO₂, WO₃, Nb₂O₅, ZrO₂, CuS, ZnS, CdS, SnS, WS₂, MoS₂; and mixtures thereof.

Advantageously, preferred semiconductors in accordance with the invention are for example TiO₂, ZnO, ZrO₂

Preferably the semiconductor material is in the form of a particle, more preferably nanoparticle having average size comprised between 1 and 100 nm, more preferably between 1 and 50 nm, still more preferably comprised between 5 and 25 nm.

Preferably the semiconductor material is TiO₂ in the form of a particle, more preferably nanoparticle having average size comprised between 1 and 100 nm, more preferably between 1 and 50 nm, still more preferably comprised between 5 and 25 nm.

By selecting the at least one monomer based on its molecular weight, it is possible to prepare modulated sensors characterized by specific oxygen response times, adaptable to various applications as a function of the necessary recoloring time.

The at least one di- or tri-acrylate monomer suitable in accordance with the invention is for example a monomer having molecular weight preferably comprised between 250 and 10000 Da.

Preferably, the at least one di- or tri-acrylate monomer suitable in accordance with the invention is selected from polyethyleneglycol diacrylate (PEGDA), ethoxylated trimethylolpropane triacrylate (EOTMPTA), high propoxylated glyceryl triacrylate (HPOGTA), tetraethyleneglycol diacrylate (TEGDA), propoxylated neopentylglycol diacrylate (PONPGDA), ethoxylated bisphenol (A) diacrylate (EOBPADA), tricyclodecane dimethanol diacrylate (TCDDA), tris-2-hydroxyethyl isocyanurate triacrylate (THEICTA); and mixtures thereof.

The molecular weight of the above-listed monomers can vary in the range considered, also for the same monomer, for example in the case of PEGDA the molecular weight can vary based on the length of the polyethylene glycol chain, in the case of ethoxylated or propoxylated monomers it can vary based on the number of such groups present in the monomer.

The redox dye methylene blue (MB, C₁₆H₁₈ClN₃SCl) is a synthetic organic compound which, due to its molecular structure, can be classified as an azo dye. It is characterized by a molar extinction coefficient equal to 19 L·mol⁻¹·cm⁻¹ at the wavelength of 254 nm and has light absorption peak in the visible region, at the wavelength of 662 nm. Following the absorption of UV radiation (photosensitization), the photocatalytic activity of the titanium dioxide semiconductor creates an electron-gap pair:

TiO₂+hv→TiO₂(e⁻,h⁺).

The variation of the energy state of the TiO₂ particle introduces a condition of non-equilibrium which can lead to the oxidation or to the reduction of adsorbed species: electrons formed can migrate on the surface of the nanoparticle and be transferred to an electron acceptor species (oxidizing agent). In the same manner, the photogenerated gap comes to oxidize an electron donor species (reducing agent).

In the specific case, a photogenerated electron reduces the redox dye (MB) to the leuco-methylene blue (LMB) form with white color.

TiO₂(e⁻,h⁺)+MB→TiO₂(h⁺)+LMB

LMB is sensitive to oxygen, such that in the absence of oxygen it remains in the form lacking color, i.e. the reduced form. Following exposure to oxygen, the non-colored LMB form is oxidized into the blue form, i.e. MB, thus acting as an oxygen indicator.

Typically, in the presence of a significant level of oxygen (>0.1%), the oxidation reaction occurs

2LMB+O₂⁻→2MB⁺+2OH.

In the dark, the LMB form is recolored to the MB form with times proportional to the percentage of oxygen present in the environment and to its capacity of diffusion in the polymer network. The recoloring can also be photochemically induced in a few minutes with a radiation in the near infrared (NIR, 730 nm). The colorimetric variation, perceptible to the naked eye, allows monitoring the presence of oxygen in the environment.

As a function of the molecular weight of the di- or tri-acrylate monomer used and of the other components used, the sensitivity to oxygen and the times of recoloring the sensitive film can be modulating, obtaining colorimetric sensors adaptable to various applications as a function of the recoloring time necessary and of the O₂ detection sensitivity.

In particular, by selecting the molecular weight of the monomer or by using a mixture of monomers, it is possible to modulate the mechanical properties of the polymer matrix and affect the coefficient of O₂ diffusion therethrough, designing sensors with different scales recoloring, from minutes to hours.

Preferably, in accordance with the first object of the invention, the process comprises subjecting the pre-polymeric solution a UVA irradiation comprised between 300 and 400 nm.

Preferably, in accordance with the first object of the invention, the process comprises subjecting the pre-polymeric solution to UVA irradiation for a time comprised between 30 seconds and 15 minutes, preferably comprised between 1 and 10 minutes, still more preferably comprised between 1 and 3 minutes.

Preferably, in accordance with the first object of the invention, the pre-polymeric solution is subjected to UVA irradiation comprised between 300 and 400 nm, and for a time comprised between 30 seconds and 5 minutes, preferably comprised between 1 and 10 minutes, more preferably between 1 and 3 minutes.

In one embodiment in accordance with the first object of the invention, the pre-polymeric solution comprises or consists of
MB,
TiO₂, preferably in the form of nanoparticles, more preferably having average size comprised between 1 and 100 nm, more preferably between 1 and 50 nm, still more preferably comprised between 5 and 25 nm,
PEGDA, preferably having molecular weight comprised between 250 and 2000 Da.

In one embodiment in accordance with the second or third object of the invention, the single-layer sensor comprises or consists of
MB,
TiO₂, preferably in the form of nanoparticles, more preferably having average size comprised between 1 and 100 nm, more preferably between 1 and 50 nm, still more preferably comprised between 5 and 25 nm,
a polymer matrix based on PEGDA, in which such monomer preferably has molecular weight comprised between between 250 and 2000 Da.

Optionally, the pre-polymeric solution in accordance with the invention further comprises a photoinitiator.

Photoinitiators that are suitable in accordance with the invention are for example DAROCUR 1173 (2-hydroxy-2-methyl-1-phenyl-1-propiophenone), IRGACURE 369 (2-benzyl-2-(dimethylamino)-1-[4-(morpholinyl) phenyl)]-1-butanone), IRGACURE 819 (phenylbis(2,4,6-trimethylbenzoyl)phosphine oxide), LAP (lithium phenyl-2,4,6-trimethylbenzoylphosphinate).

Preferably the photoinitiator is added in a percentage in the range comprised between 0.5 and 2% v/v, with respect to the total volume of the pre-polymeric solution; the Applicant has observed that the photoinitiator accelerates the polymerization speed and activation of the sensor.

Also by using the photoinitiator, it is possible to trigger the polymerization reaction also of an acrylic monomer with high molecular weight, for example up to 10000 Da.

In addition the photoinitiator allows obtaining a reversible sensor having improved mechanical properties.

The sensors of the embodiments in accordance with the invention in which a photoinitiator is not present are irreversible and hence cannot be reused.

Optionally, the pre-polymeric solution in accordance with the invention further comprises a sacrificial electron donor (SED).

SED that are suitable in accordance with the invention are weak reducing agents such as amines, e.g. NaEDTA and TEOA; reducing saccharides, for example glucose or fructose; easily-oxidizable polymers, e.g. polyvinyl alcohol; other anti-oxidants, e.g. ascorbic acid or citric acid; easily-oxidizable materials, e.g. glycerol or threitol; and mixtures thereof.

When present, the SED reduces the oxidative photocatalytic degradation of the dye (e.g., MB) and allows decoloring/recoloring the film without causing the degradation of the dye itself for a successive number of cycles.

The sensor obtained in the presence of semiconductor material, of photoinitiator and of SED, in addition to being reversible, can be reused for a number of cycles greater than the sensor obtained in the presence of semiconductor material and of photoinitiator, without SED. Indeed the system can be re-exposed to UVA radiations after the recoloring at air, since the MB has returned to the leuco oxidized form and the TiO₂ preserves its catalytic activity.

In another embodiment in accordance with the first object of the invention, the process for the preparation and activation of a sensor for detecting oxidizing agents comprises
subjecting to UV irradiation, comprised between 200 and 400 nm, a pre-polymer solution comprising at least one redox dye, at least one semiconductor material, at least one photoinitiator and at least one di- or tri-acrylate monomer, and optionally at least one SED.

In another embodiment in accordance with the second or with the third object of the invention, the single-layer sensor comprises
at least one redox dye,
at least one semiconductor material
at least one photoinitiator,
a polymer matrix based on at least one di- or tri-acrylate monomer and optionally at least one SED.

In a preferred embodiment in accordance with the invention, the pre-polymeric solution comprises or consists of
MB,
TiO₂, preferably in the form of nanoparticles, more preferably having average size comprised between 1 and 100 nm, more preferably between 1 and 50 nm, still more preferably comprised between 5 and 25 nm,
DAROCUR 1173
PEGDA, preferably having molecular weight comprised between 250 and 10000 Da.

In a preferred embodiment in accordance with the second or with the third object of the invention, the single-layer sensor comprises or consists of
MB,
TiO₂, preferably in the form of nanoparticles, more preferably having average size comprised between 1 and 100 nm, more preferably between 1 and 50 nm, still more preferably comprised between 5 and 25 nm.
DAROCUR 1173
a polymer matrix based on PEGDA, in which such monomer preferably has molecular weight comprised between 250 and 10000 Da.

The sensors of the preferred embodiments in accordance with the second or with the third object of the invention, in which also the photoinitiator is present, are reversible and they can be reused for a certain number of cycles.

In one embodiment in accordance with the fourth object of the invention, the multilayer sensor comprises
a single-layer sensor comprising or consisting of
   MB,
   TiO₂, preferably in the form of nanoparticles, more preferably having average size comprised between 1 and 100 nm, more preferably between 1 and 50 nm, still more preferably comprised between 5 and 25 nm,
   a polymer matrix based on PEGDA, preferably in which such monomer has molecular weight comprised between 250 and 10000 Da.
at least one further polymer layer based on at least one di- or tri-acrylate monomer, preferably PEGDA, more preferably in which such monomer has molecular weight comprised between 250 and 10000 Da.

In another embodiment in accordance with the fourth object of the invention, the multilayer sensor comprises
a single-layer sensor comprising or consisting of
   MB,
   TiO₂, preferably in the form of nanoparticles, more preferably having average size comprised between 1 and 100 nm, more preferably between 1 and 50 nm, still more preferably comprised between 5 and 25 nm,
   DAROCUR,
   a polymer matrix based on PEGDA, in which such monomer has molecular weight comprised between 250 and 10000 Da.
at least one further polymer layer based on at least one di- or tri-acrylate monomer, preferably PEGDA, in which such monomer has molecular weight comprised between 250 and 10000 Da.

In such multilayer embodiments, the diffusion of the oxygen is slowed and the re-oxidation times of the leuco form of the methylene blue are lengthened, hence the sensors having for example a double or triple polymer layer which contains the colorimetric sensor are characterized by longer recoloring times.

### EXPERIMENTAL PART

### Example 1) Preparation of Single-Layer Colorimetric Sensors in Accordance with the Invention

### Materials Used

Methylene blue (MB) and PEGDA 575, 700, 10000 Da were purchased from Sigma-Aldrich; TiO₂ was prepared as reported below.

### TiO₂ Nanoparticles (NP) Synthesis

In a 50 ml becker, the following were added: 10 ml of diethylene glycol (DEG), 300 mg of poly(ethylene glycol)-b-poly(propylene glycol-b-poly(ethylene glycol) (P123), 250 uL of NaOH, 250 uL of TiCl₄. The mixture was heated to 250° C. for 3 h, in continuous magnetic stirring and then cooled at room temperature. At the end of the reaction, the particles precipitated in acetone and a white precipitate was observed, subsequently centrifuged three times at 10000 rpm for 10 min at room temperature.

### TiO₂ NP Characterization

The TiO₂ particles prepared by means of the above-described synthesis were characterized by means of Dynamic Light Scattering (DLS) with Zetasizer Nano ZS, Malvern Instruments, U.K., (equipped with 633 nm HeNe laser, fixed scattering angle 173°, 25° C.), in order to evaluate the weighted average hydrodynamic size of the particles (Z-average; d, nm), and at the Spectrophotometer (UV-VIS, Cary 100 spectrometer, VARIAN) in order to evaluate the absorption of the particles.

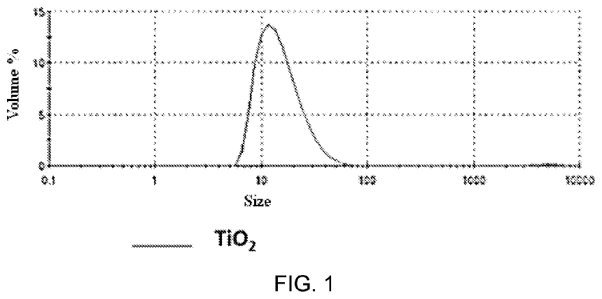

As shown in FIG. 1 and in table 1, the particles had average dimensions of about 16 nm. The polydispersion index was equal to about 0.4.

TABLE 1

| | | | Standard |
|---|---|---|---|
| | Size | | Deviation |
| | (d, nm) | Volume % | (d, nm) |
| Peak 1 | 15.87 | 99.4 | 8.067 |
| Peak 2 | 4.770 | 0.6 | 932.2 |

### a) Preparation of a Colorimetric Sensor 1 Comprising TiO₂/575 Da PEGDA/MB

5 mg of NP TiO₂ were solubilized in 50 uL of H₂O MilliQ. To this solution, 500 uL of 575 Da PEGDA and 10 uL of MB (0.1 M) were added, the solution was stirred for 5 min. 100 uL of such solution was added between two 15×15 mm slides and the sample was exposed to the UVA radiation of a contact copier (UV-exposure box, UV-Belichtungsgerät 2) at a wavelength between 300 and 400 nm for 1 minute, obtaining the colorimetric sensor 1 whitish, in film form.

### b) Preparation of a Colorimetric Sensor 2 Comprising TiO₂/700 Da PEGDA/MB

5 mg of NP TiO₂ were solubilized in 50 uL of H₂O MilliQ. To this solution, 500 uL of 700 Da PEGDA and 10 uL of MB (0.1 M) were added, the solution was stirred for 5 min. 100 uL of such solution were placed between two 15×15 mm slides and the sample was exposed to UVA radiation of a contact copier (UV-exposure box, UV-Belichtungsgerät 2) at a wavelength between 300 and 400 nm for 1 minute, obtaining the colorimetric sensor 2 whitish, in film form.

### c) Preparation of a Colorimetric Sensor 3 Comprising TiO₂/575 Da PEGDA/MB/PI

5 mg of NP TiO₂ were solubilized in 50 uL of H₂O MilliQ. To this solution, 500 uL of 575 Da PEGDA were added with 2% Darocur 1173 and 10 uL of MB (0.1 M), the solution was stirred for 5 min. 100 uL of such solution were placed between two 15×15 mm slides and the sample was exposed to the UV radiation of a contact copier (UV-exposure box, UV-Belichtungsgerät 2) at a wavelength between 300 and 400 nm for 1 minute, obtaining the colorimetric sensor 3 colorless, in film form.

### d) Preparation of a Colorimetric Sensor 4 Comprising TiO₂/700 Da PEGDA/MB/PI

5 mg of NP TiO₂ were solubilized in 50 uL of H₂O MilliQ. To this solution, 500 uL of 700 Da PEGDA were added with 2% Darocur 1173 and 10 uL of MB (0.1 M), the solution was stirred for 5 min. 100 uL of such solution were placed between two 15×15 mm slides and the sample was exposed to the UVA radiation of a contact copier (UV-exposure box, UV-Belichtungsgerät 2) at a wavelength between 300 and 400 nm for 1 minute, obtaining the colorimetric sensor 4 colorless, in film form.

### e) Preparation of a Colorimetric Sensor 5 Comprising TiO₂/PEGDA 10000 Da/MB/PI

5 mg of NP TiO₂ were solubilized in 50 uL of H₂O MilliQ. To this solution, 500 uL of PEGDA 10000 Da (100 mg/mL in H₂O) were added with the 2% Darocur 1173 and 10 uL of MB (0.1 M), the solution was stirred for 5 min. 100 uL of such solution were placed between two 15×15 mm slides and the sample was exposed to the UVA radiation of a contact copier (UV-exposure box, UV-Belichtungsgerät 2) at a wavelength between 300 and 400 nm for 1 minute, obtaining the colorimetric sensor 5 colorless, in film form.

The obtained films had a thickness of about 440 μm.

As demonstrated in the examples 1a and 1b, the semiconductor material TiO₂ is capable of catalyzing the polymerization reaction of an acrylic monomer and of reducing MB from the colored oxidized form to the colorless reduced LMB form; in this manner, the preparation and the activation of a colorimetric sensor is advantageously attained in a single step and with an exposure time of the pre-polymeric solution at the UVA radiation that is quite brief, about 1 minute.

As demonstrated in the examples in the examples 1c, 1d and 1e in the presence of the semiconductor material TiO₂ and of the photoinitiator Darocur 1173, the exposure time of the pre-polymeric solution to the UVA radiation is analogous to the exposure time of the pre-polymeric solution in which only TiO₂ is present.

As demonstrated in the example 1e, in the presence both of TiO₂ and of Darocur 1173 it is possible to trigger the polymerization reaction of an acrylic monomer also with high molecular weight, for example up to 10000 Da.

### Example 2—Preparation of a Multilayer Colorimetric Sensor 6 in Accordance with the Invention

The film 3 comprising TiO₂/575 Da PEGDA/MB/PI was prepared, as described in the example 1c.

Subsequently, for dropping, a solution comprising 50 uL of PEGDA575 with 2% Darocur 1173 (white) was placed on the upper part of such film and polymerized for 1 min of UVA between the film 3 and a 15*15 mm slide. At the end, the bi-layer film (i.e., (3)/white) was overturned and on the top 50 uL of a solution PEGDA575 at 2% Darocur 1173 (white) was placed, which was then polymerized by a UVA radiation for 1 minute between the bi-layer and a slide. A three-layer film (tri-layers) is obtained (i.e., white/(3)/white).

### Example 3—Analysis of the Colorimetric Transition in the Presence of Oxygen by Single-Layer and Multilayer Colorimetric Sensors in Accordance with the Invention

The single-layer films 1-5 prepared as described in the example 1 and the multilayer film 6 prepared as described in the example 2, were exposed to atmospheric oxygen at room temperature (25° C.) and in the dark and analyzed by means of spectroscopy in transmission at normal incidence. The setup was constituted by a halogen lamp (Hamamatsu High power UV-VIS light source). 2 multimode optical fibers (Thorlabs 400-2200 nm), one for the source and one for the spectrophotometer used for acquiring the spectra (Optical Spectrum Analyser Ando AQ-6315B). The analysis interval was between 550 nm and 750 nm, which is the absorption interval of the MB. A sensitive “white” film lacking MB was used as reference. The data was processed with Originpro2016 and normalized with respect to the minimum value at 750 nm. The maximum absorption peak at 670 nm was selected for evaluating the reaction kinetics of the re-oxidation of the MB. When the maximum absorption peak no longer varied over time, it was assumed that all the LMB form had been re-oxidized into MB.

In the case of the single-layer films, the analysis was carried out at regular time intervals at 1, 5, 15, 30, 60 and 90 min up to reaching a recoloring plateau. In the case of the multilayer film, the analysis was carried at regular time intervals at 60, 180, 420, 1140, 1440 and 2880 min up to reaching a recoloring plateau. In order to verify that the action of recoloring was attributable to the atmospheric oxygen, a sample of each of the prepared films was maintained between 2 glass slides which limit the permeation of atmospheric gas and placed in a Schlenk tube in an N₂ atmosphere for 90 min: in these conditions, the sample of each of the films 1-6 it remained colorless.

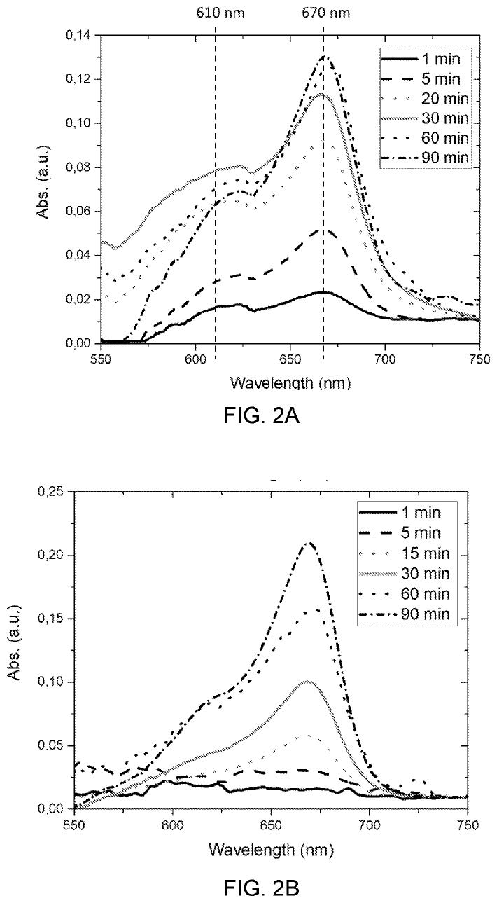

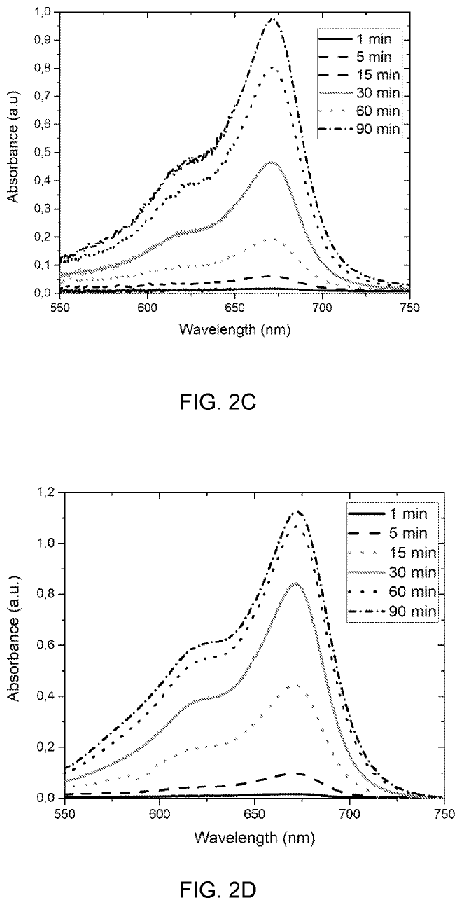

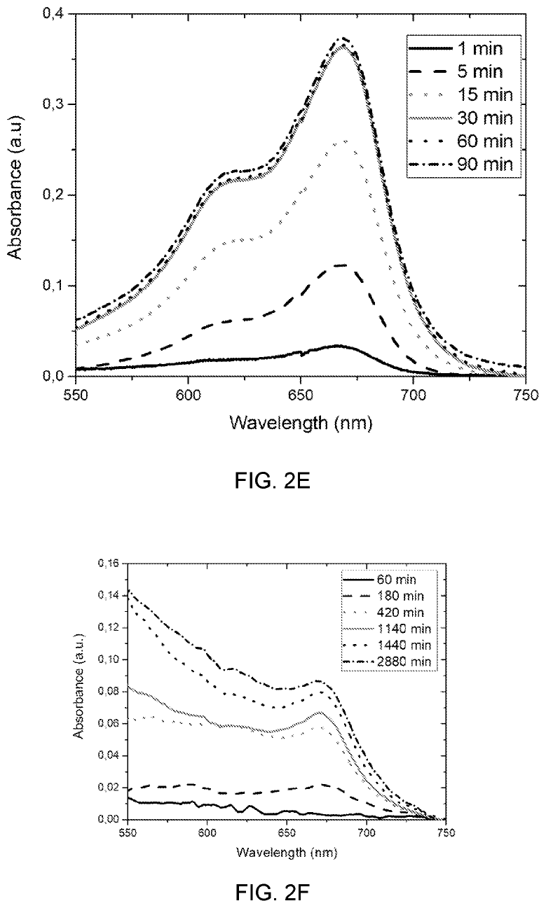

FIGS. 2A-2E respectively show the visible spectrum between 550 nm and 750 nm of MB in the single-layer films from 1 to 5 according to the invention following the exposure to atmospheric oxygen at room temperature (25° C.) and in the dark;
as shown by the peak at λmax equal to 670 nm corresponding to the absorption peak of MB, in all the films in the test conditions there is the re-oxidation of the LMB form into MB;
the maximum absorption peak of MB was reached within 90 minutes also for the films 1 and 2 in which TiO₂ is present and the photoinitiator is not present, see FIGS. 2A and 2B.

Comparing FIGS. 2A and 2B with the FIGS. 2C, 2D and 2E corresponding respectively to films 1 and 2 and to films 3, 4 and 5, at λmax equal to 610 nm, corresponding to the absorption peak of the dimer form of MB, it is known that the dimer form is present in a lower percentage in the films 3, 4 and 5 also comprising the photoinitiator, which signifies that in such films the initial coloring is restored in a more complete manner.

FIG. 2F shows the visible spectrum between 550 nm and 750 nm of the MB in the multilayer film 6 according to the invention, following the exposure of the film to the atmospheric oxygen at room temperature (25° C.) and in the dark.

As shown by the peak at λmax equal to 670 nm, also in this case of the test conditions, there is the reoxidation of the LMB form into MB, the maximum absorption peak of MB was reached in about 48 hours, i.e. in much longer times than the times of the single-layer films 1-5.

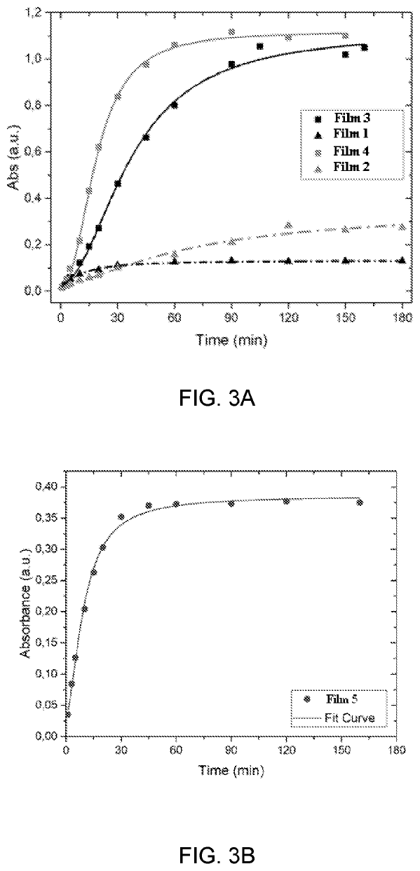

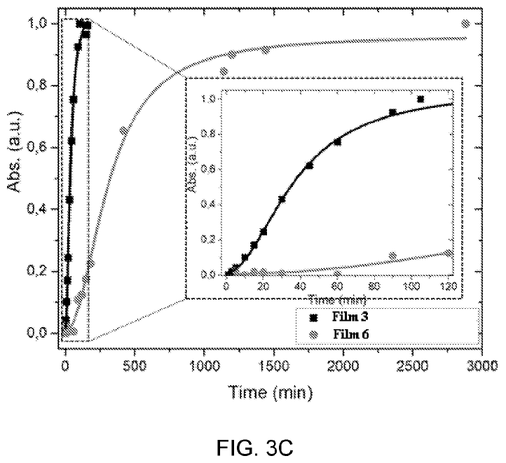

FIG. 3A shows the kinetics of recoloring of the single-layer films 1 (black triangle) and 2 (gray triangle) compared with the kinetics of the films 3 (black square) and 4 (gray square) following the recoloring of the leuco-MB form in the oxidized MB form by the atmospheric oxygen at room temperature and in the dark. FIG. 3B shows the kinetics of recoloring the single-layer film 5.

As shown in the figures, the colorimetric transition of all the films reaches the plateau within 90 minutes.

As is shown in FIG. 3A, the colorimetric transition of the film 3 (black square) and of the film 4 (gray square) reaches the plateau respectively at 90 and 60 min. As shown in FIG. 3B, the colorimetric transition of the film 5 reaches the plateau at 30 min.

As results from the tests conducted, the use of PEGDA at different molecular weight, the other conditions being the same, determines a different kinetics of recoloring of the film in accordance with the invention when exposed to the atmospheric oxygen at room temperature and in the dark.

In particular, in the film 3, prepared by exposing to UV radiation the sample comprising PEGDA at low molecular weight (575 Da), the crosslinking determines a denser polymer matrix, therefore the oxygen spreads more slowly in the film and consequently the response time of the sensor is greater (90 min).

In the film 5, prepared by exposing to UV radiation the sample comprising PEGDA with high molecular weight (10000 Da), the crosslinking determines a less dense polymer matrix, hence the oxygen diffuses more quickly in the film and consequently the response time of the sensor is lower (30 min).

In the film 4, prepared by exposing to UV radiation the sample comprising PEGDA at intermediate molecular weight (700 Da), the response time of the sensor is intermediate with respect to the preceding (60 min).

From this data, it is inferred that by selecting the at least one monomer based on the molecular weight, it is possible to prepare modulated sensors characterized by specific re-oxidizing time.

FIG. 3C shows the kinetics of recoloring the multilayer film 6 (gray circle) compared with the kinetics of the single-layer film 3 (black square); the presence of two layers of PEGDA 575/PI above and below the layer TiO₂/PEGDA 575/MB/PI significantly slows the recoloring process. As is inferred by comparing the two graphs, while the single-layer sensor 3 shows a complete recoloring after 90 min, the multilayer sensor 6 reaches a complete recoloring only after about 48 hours.

This further data proves that in the multilayer sensors the diffusion of the oxygen is slowed and the re-oxidizing times of the leuco form of the methylene blue are lengthened; therefore the multilayer sensors are characterized by longer recoloring times.

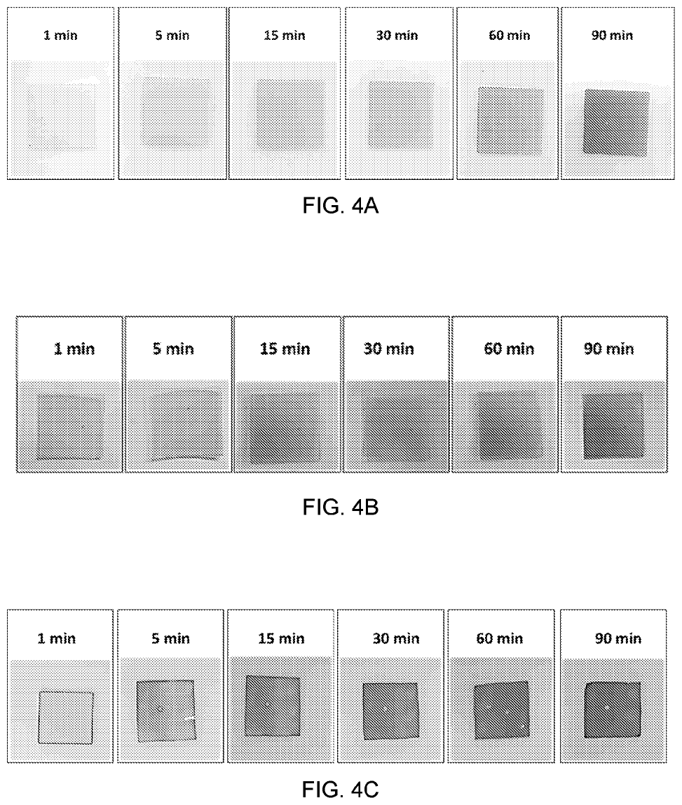

FIGS. 4A-4C show the photographic images of the films from 3 to 5 taken at 1, 5, 15, 30, 60 and 90 min. From these images, even with the naked eye it is possible to see that the colorimetric transition of the films 3 obtained starting from an acrylic monomer at lower molecular weight (575 Da) is slower and reaches the plateau in 90 min, that the colorimetric transition of the film 5 obtained starting from an acrylic monomer with higher molecular weight (10000 Da) is the fastest and reaches the plateau in 30 min, and finally that the colorimetric transition of the film 4 obtained starting from an acrylic monomer at intermediate molecular weight (700 Da) reaches the plateau in 60 min.

The mechanical properties of the films in accordance with the invention result correlated to the molecular weight of the acrylic monomer, for example the film 5 is softer with a high water content with respect to the films (4) and (3).

In addition, the mechanical properties of the films in accordance with the invention result correlated also with the presence of the photoinitiator which, when present, determines a more crosslinked system; consequently the films 3, 4 and 5 are more elastic and mechanically more stable than the films 1 and 2.

In summary, as shown in the experimental part, the process in accordance with the invention is advantageously attained in a single step which comprises the preparation and the activation of the sensor, hence such process is simpler and less expensive than the processes described in WO252 and WO849 in which preparation and activation of the sensor occurred in separate steps. Moreover, a few minutes of irradiation with UV light are sufficient for preparing and activating the sensor in accordance with the invention, even in the presence of only semiconductor material without photoinitiator.

A further advantage of the process in accordance with the invention is represented by the fact that by selecting at least one monomer based on the molecular weight, it is possible to prepare modulated sensors characterized by specific oxygen response times, adaptable to various applications as a function of the necessary recoloring time.

1. A process for the preparation and activation of a sensor, comprising
subjecting to UV irradiation of 200 to 400 nm a pre-polymeric solution comprising at least one redox dye, at least one semiconductor material and at least one di- or tri-acrylate monomer.

2. The process according to claim 1, wherein
said at least one redox dye is selected from the group consisting of a thiazine dye, an oxazine dye, an azine dye, an indophenol dye, an indigo dye; a viologen dye, an eurhodin dye, and mixtures thereof;
and/or
said at least one semiconductor material is a metal oxide (MOSs),
and/or
said at least one di- or tri-acrylate monomer is selected from the group consisting of polyethyleneglycol diacrylate (PEGDA), ethoxylated trimethylolpropane triacrylate (EOTMPTA), high propoxylated glyceryl triacrylate (HPOGTA), tetraethyleneglycol diacrylate (TEGDA), propoxylated neopentylglycol diacrylate (PONPGDA), ethoxylated bisphenol (A) diacrylate (EOBPADA), tricyclodecane dimethanol diacrylate (TCDDA), tris-2-hydroxyethyl isocyanurate triacrylate (THEICTA); and mixtures thereof.

3. The process according to claim 1, wherein said pre-polymeric solution
is subjected to UVA irradiation for a time of 30 seconds to 15 minutes;
and/or
further comprises at least one photoinitiator, and
optionally at least one sacrificial electron donor (SED).

4. The process according to claim 1, wherein
the pre-polymeric solution comprises
MB,
TiO₂,
DAROCUR 1173
PEGDA.

5. A single-layer sensor, comprising a sensor obtained by means of the process described according to claim 1.

6. A single-layer sensor, comprising
at least one redox dye in its leuco form,
at least one semiconductor material, and
a polymer matrix based on at least one di- or tri-acrylate monomer.

7. A sensor according to claim 5, further comprising
at least one photoinitiator.

8. A sensor according to claim 5, comprising
MB,
TiO₂,
DAROCUR 1173
a polymer matrix based on PEGDA.

9. A multilayer sensor, comprising
a single-layer sensor according to claim 5, and
at least one further polymer layer based on at least one di- or tri-acrylate monomer.

10-11. (canceled)

12. A sensor according to claim 7, further comprising at least one sacrificial electron donor (SED).

13. A method for detecting an oxidizing agent inside a package, comprising providing a sensor according to claim 5 inside said package.

14. The method according to claim 13, wherein said package contains a food or pharmaceutical.

15. The process according to claim 1, wherein said pre-polymeric solution is subjected to UV irradiation of 300 to 400 nm.

16. The process according to claim 1, wherein said at least one semiconductor material is a metal oxide (MOSs) selected from the group consisting of TiO₂, ZnO, SnO₂, WO₃, Nb₂O₅, ZrO₂, CuS, ZnS, CdS, SnS, WS₂, MoS₂ and mixtures thereof;

17. The process according to claim 1, wherein said at least one semiconductor material is in the form of nanoparticles.

18. The process according to claim 17, wherein said nanoparticles have an average size of 1 to 100 nm.

19. The process according to claim 17, wherein said nanoparticles have an average size of 1 to 50 nm.

20. The process according to claim 17, wherein said nanoparticles have an average size of 5 to 25 nm.

21. The process according to claim 1, wherein said pre-polymeric solution is subjected to UVA irradiation for a time of 1 to 10 minutes.

22. The process according to claim 3, wherein said at least one photoinitiator is selected from the group comprising DAROCUR 1173 (2-hydroxy-2-methy-1-phenyl-1-propiophenone), IRGACURE 369 (2-benzyl-2-(dimethylamino)-1-[4-(morpholinyl)phenyl)]-1-butanone), IRGACURE 819 (phenylbis(2,4,6-trimethylbenzoyl)phosphine oxide), and LAP (lithium phenyl-2,4,6-trimethylbenzoylphosphinate).
